(19) United States
(12) Patent Application Publication
(10) Pub. No.: US 2014/0147368 A1
(43) Pub. Date: May 29, 2014

(54) METHOD FOR PREPARING GRAPHENE OXIDE

(71) Applicant: NATIONAL CHENG KUNG UNIVERSITY, Tainan City (TW)

(72) Inventors: JYH-MING TING, Tainan City (TW); TIEN-TSAI WU, Tainan City (TW)

(73) Assignee: NATIONAL CHENG KUNG UNIVERSITY, Tainan City (TW)

(21) Appl. No.: 13/900,604

(22) Filed: May 23, 2013

(30) Foreign Application Priority Data
Nov. 23, 2012 (TW) 101143874

(51) Int. Cl. C01B 31/04

(52) U.S. Cl. CPC C01B 31/043
USPC 423/415.1

(57) ABSTRACT

The present invention relates to a method for preparing graphene oxide with high yield, in which the yield is increased by controlling the amount and addition rate of each component.

### BACKGROUND OF THE INVENTION

1. Field of the Invention

The present invention relates to a method for preparing graphene oxide with high yield, and the graphene oxide produced by said method.

2. Description of the Related Art

Graphite oxide was first reported by Brodie^{[1]} in 1859. Since the report, various groups have followed this method to synthesize graphite oxide for microstructural analysis^{[2]}, to further fabricate graphene^{[3,4]}, and to study the functionalization of graphite oxide^{[5]}. In 1898, a modified method (i.e., the Staudenniaier-Hofmann-Hamdi method) was reported^{[6-8]}. However, the above processes consume time and involve vigorous reaction kinetics that often result in, for example, spontaneous ignition or explosion of potassium chlorate^{[9]}. Therefore, a rapid, relatively safe method, named as Hummers method, was developed for preparing graphene oxide, in which sulfuric acid, sodium nitrate, graphite flakes, and potassium permanganate are mixed in sequence, followed by addition of deionized water (DI water) to form graphene oxide. Recently, another method was reported, which involves the use of a strong oxidizer (i.e., benzoyl peroxide) and fine graphite powders^{[10,11]} to produce graphene oxide. This process requires heating at 110° C. and therefore extra care must be paid to avoid explosion in the closed container. As a result, the Hummers method remains as the most popular method due to its safety and ease in fabrication.

In recent studies, the graphene oxide prepared by Hummers method has been used for the microstructure of transmission electron microscopy (TEM)^{[12]}, subjected to post-synthesis treatments for understanding the property variations^{[13]}, and used as the material for field-effect devices^{[14]}. However, the optimization of the synthesis conditions of Hummers method has not been reported yet.

### SUMMARY OF THE INVENTION

The object of the present invention is to provide a method for preparing graphene oxide with high yield, and the graphene oxide produced by said method. Said method is an improved Hummers method, in which the yield is increased by controlling the amount and addition rate of each component.

To achieve the object, the present invention provides a method for preparing graphene oxide, comprising:
(a) adding sodium nitrate into sulfuric acid to obtain a sodium nitrate solution in sulfuric acid;
(b) adding graphite into said sodium nitrate solution in sulfuric acid to obtain expanded graphite;
(c) adding potassium permanganate into said expanded graphite, in which the ratio of sodium nitrate/potassium permanganate is 0.12-0.27, to obtain a graphite suspension;
(d) adding deionized water into said graphite suspension to control the yield of graphene oxide, in which said deionized water is added at a rate of 2-8 mL/min.

In a preferred embodiment, said graphene oxide is an amorphous graphene oxide having a layered structure; more preferably, said layered structure has 12 layers or less.

In a preferred embodiment, said method further comprises: (e) filtering the graphite suspension obtained from step (d); more preferably, filtering by a filter of #200 mesh.

In a preferred embodiment, said method further comprises: (f) purifying the filtrate obtained from step (e); more preferably, purifying the filtrate by an anion and cation exchange resin.

In a preferred embodiment, the ratio of sodium nitrate:sulfuric acid:graphite is 0.4-0.8 g:25-40 mL:1.3 g; more preferably, 0.6 g:25 mL:1.3 g.

In a preferred embodiment, the ratio of sodium nitrate/potassium permanganate is 0.13-0.18; more preferably, 0.16.

In a preferred embodiment, said sodium nitrate is added at a rate of 6-10 mg/s; more preferably, at a rate of 8 mg/s.

In a preferred embodiment, said graphite is added at a rate of 2-6 mg/s; more preferably, at a rate of 4 mg/s.

In a preferred embodiment, said potassium permanganate is added at a rate of 12-18 mg/s; more preferably, at a rate of 15 mg/s.

In a preferred embodiment, said deionized water is added at a rate of 1-3 mL/min; more preferably, at a rate of 2 mL/min.

The present invention also provides an amorphous graphene oxide having a layered structure, which is prepared by the above-mentioned method.

In a preferred embodiment, said amorphous graphene oxide having a layered structure has 12 layers or less.

### BRIEF DESCRIPTION OF THE DRAWINGS

FIG. 1 represents the diagram of the DI water addition rate and the average yield of graphene oxide.

FIG. 2 represents the diagram of NaNO₃/KMnO₄ ratio and the yield of graphene oxide.

FIG. 3(A) shows the XRD spectra of Samples 2 and 4. FIG. 3B shows the XRD spectra of Sample 5.

FIG. 4(A) shows the Raman spectra of Samples 1-9. FIG. 4B shows the Raman spectra details of Sample 2.

FIG. 5A represents the TEM image of Sample 2, in which a silk-veil-like structure is observed. FIG. 5B represents the TEM image of Sample 2, in which a curled edge is observed. FIG. 5C shows the SAED pattern of Sample 2.

FIG. 6A shows the C1s spectrum of Sample 2. FIG. 6B shows the high-resolution O1s spectra of Sample 2.

FIG. 7A shows the light transmittance of coatings prepared by suspensions with different concentrations of the graphene oxide of Sample 2. FIG. 7B shows the light transmittance of Samples 2, 5, 6, 7 and a PET substrate without coating.

### DETAILED DESCRIPTION OF THE PREFERRED EMBODIMENTS

The present invention provides a modified Hummers method, in which the yield of graphene is improved by controlling the ratio and the addition date of components.

The examples of the present invention are provided hereinafter, however, these examples are not used for limit the scope of the present invention. Various change and modification can be made by those skilled in the art without departing from the scope of the invention.

### EXAMPLES

### Example 1

### Preparation of the Graphene Oxide of the Present Invention

0.4 g, 0.6 g or 0.8 g of sodium nitrate (NaNO₃) was added into 25 mL, 30 mL or 40 mL of 18 M sulfuric acid to give sodium nitrate solutions in sulfuric acid with various sodium concentrations. In order to fully dissolve sodium nitrate in a determined period of time, sodium nitrate had to be slowly added into sulfuric acid. In this example, sodium nitrate was added into sulfuric acid at a rate of 8 mg/s.

1.3 g of graphite flakes was subsequently added. The graphite flakes were moisturized and expanded, and give chemical baths comprising expanded graphite. The chemical baths were stirred at 150 rpm during the whole process. Na⁺ and NO₃⁻ ions from sodium nitrate would insert into the graphite flakes to form the expanded graphite. The graphite flakes had to be slowly added into the sodium nitrate solution in sulfuric acid, or the graphite flakes could not be fully moisturized. In this example, graphite flakes were added into the sodium nitrate solution in sulfuric acid at a rate of 4 mg/s.

The chemical baths were kept at 20° C. or below by using ice bath. Subsequently, 3.0 g, 3.8 g or 4.6 g of potassium permanganate (KMnO₄) was added into the resulting chemical baths. Similarly, potassium permanganate had to be slowly added to give a homogeneous suspension. In this example, potassium permanganate was added into the chemical bath at a rate of 15 mg/s.

After KMnO₄ addition, the ice bath was removed, and the temperature of the chemical baths would increase to 35±3° C. At this time, deionized water (DI water) having a temperature of 40-50° C. was dropped into chemical baths at a rate of 2, 8, or 14 mL/min to maintain the bath temperature at 30° C. or above. The addition of potassium permanganate resulted in hydrolysis reaction and formation of graphene oxide (GO). The reactions are shown as the following formula (1) and (2).

4KMnO₄+2H₂O→4KOH+4MnO₂+3O₂ (1)

C(graphite flakes)+nO₂→GO (2)

The sample number and conditions of preparation are listed in Table 1:

TABLE 1

| | Addition rate | Sulfuric | | | NaNO₃/ | |
|---|---|---|---|---|---|---|
| | of DI water | acid | NaNO₃ | KMnO₄ | KMnO₄ | yield |
| | (mL/min) | (mL) | (g) | (g) | ratio | (mg) |
| Sample 1 | 2 | 25 | 0.4 | 3.0 | 0.13 | 145.8 |
| Sample 2 | 2 | 30 | 0.6 | 3.8 | 0.16 | 282.8 |
| Sample 3 | 2 | 40 | 0.8 | 4.6 | 0.17 | 206.3 |
| Sample 4 | 8 | 25 | 0.6 | 4.6 | 0.13 | 269.8 |
| Sample 5 | 8 | 30 | 0.8 | 3.0 | 0.27 | 97.8 |
| Sample 6 | 8 | 40 | 0.4 | 3.8 | 0.11 | 219.3 |
| Sample 7 | 14 | 25 | 0.8 | 3.8 | 0.21 | 160.8 |
| Sample 8 | 14 | 30 | 0.4 | 4.6 | 0.09 | 118.3 |
| Sample 9 | 14 | 40 | 0.6 | 3.0 | 0.20 | 160.3 |

When the DI water was added, violent chemical reaction happened and gasses including oxygen bubbled, that is to say, effervescence occurred. The chemical baths became gel-like with increased temperature. The increase of the bath temperature was generally proportional to the DI water addition rate.

Warm hydrogen peroxide (H₂O₂) aqueous solution (3 wt. %) was used to dilute the gel-like chemical baths. Hydrogen peroxide would reduce the remained potassium permanganate to produce soluble manganese oxide (MnO₄) and manganese sulfate (MnSO₄). So the gel-like chemical baths became liquid-like. The diluted liquid-like baths were subsequently subjected to centrifugation at 2500 rpm for 10 minutes, and the supernatant suspensions were collected. The above dilution, centrifugation and collection were repeated until no supernatant suspension could be obtained by centrifugation.

The collected suspensions were filtered by a filter of #200 mesh (0.074 mm/mesh) (Bunsekifurui, Mesh 200) to remove large impurity and resin particles. Subsequently, they were was subjected to pass an anion and cation exchange resin (Alfa Aesar, NM-65) to remove salt impurity. The resulted filtrates were centrifuged and dried to give the graphene oxide of the present invention. The graphene oxide of each sample was weighted and the yield (mg) was calculated.

### Example 2

### Yield Analysis of the Method for Preparing Graphene Oxide of the Present Invention

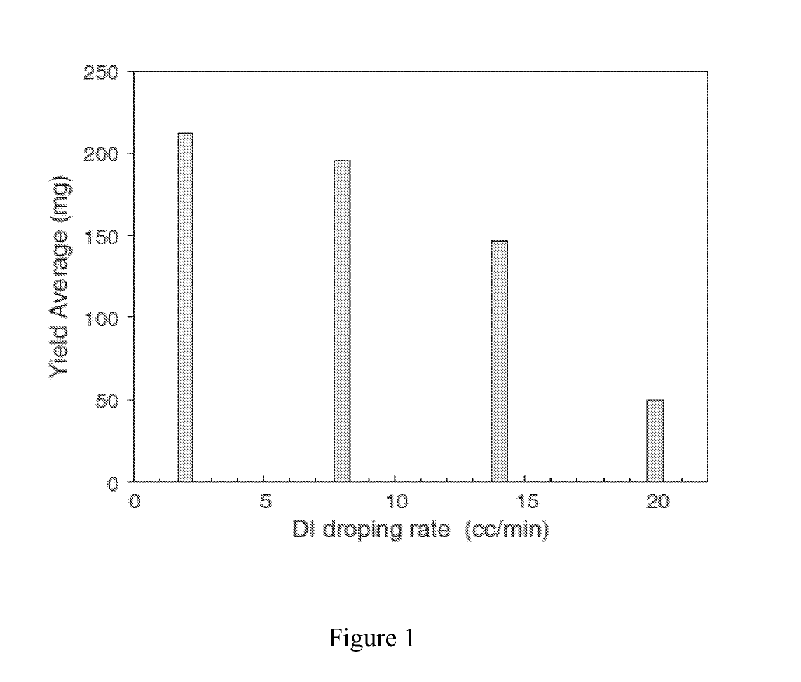

FIG. 1 represents the diagram of the water addition rate and the average yield of graphene oxide of Example 1. When the chemical concentrations are not taken into consideration, it is found that the yield of graphene oxide is reduced when the addition rate of water increases. In addition, the method of the present invention produces oxygen, which results in effervescence. The degree of effervescence increases with the water addition rate, and it causes loss of oxygen and reduction of graphene oxide yield. Therefore, the best addition rate of DI water of all samples of Table 1 is 2 mL/min.

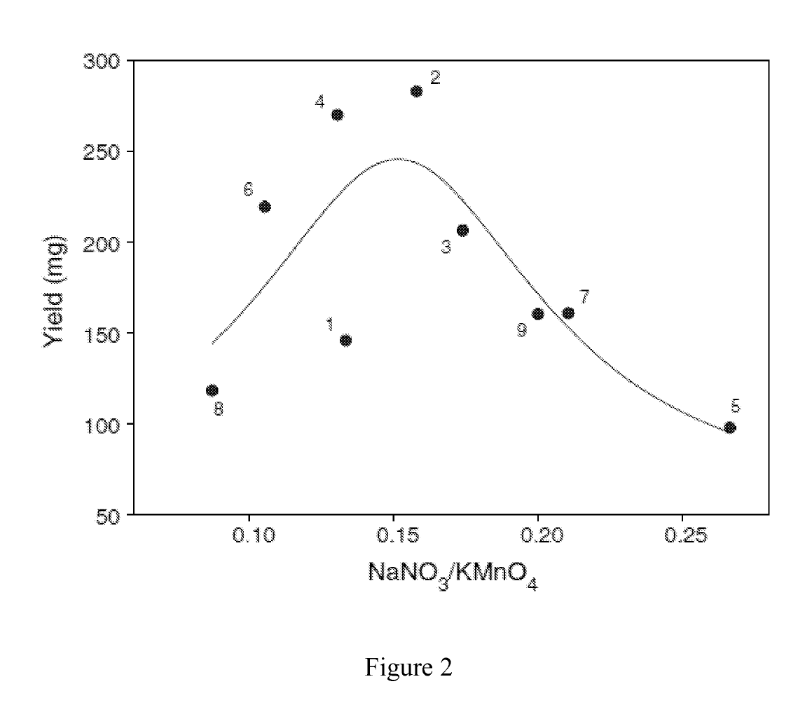

The NaNO₃/KMnO₄ ratio also affects the yield of graphene oxide. When the NaNO₃/KMnO₄ ratio is low, the amount of NaNO₃ is low, and no sufficient expanded graphite is formed. When the NaNO₃/KMnO₄ ratio is high, the amount of KMnO₄ is low, the graphene oxide cannot be formed. Both the two situations lowered the yield of graphene oxide, as shown in FIG. 2. Since Sample 2 is the sample having the maximum yield among all samples of Table 1, the best NaNO₃/KMnO₄ ratio is 0.6 g/3.8 g=0.16.

In addition, sulfuric acid also affects the yield (data not shown), and the preferred concentration of sulfuric acid is the samples prepared by using 40 mL of sulfuric acid, and the concentration thereof is 94.33%.

### Example 3

### Qualitative Analysis of the Graphene Oxide of the Present Invention

### (1) X-ray Diffractometry (XRD)

The graphene oxide powder of Samples 1-9 obtained in Example 1 were subjected to XRD analysis. Data was collected using Cu—Kα radiation by D-max X-ray diffractometer (Rigaku) (λ=1.54018 Å, angle=4°).

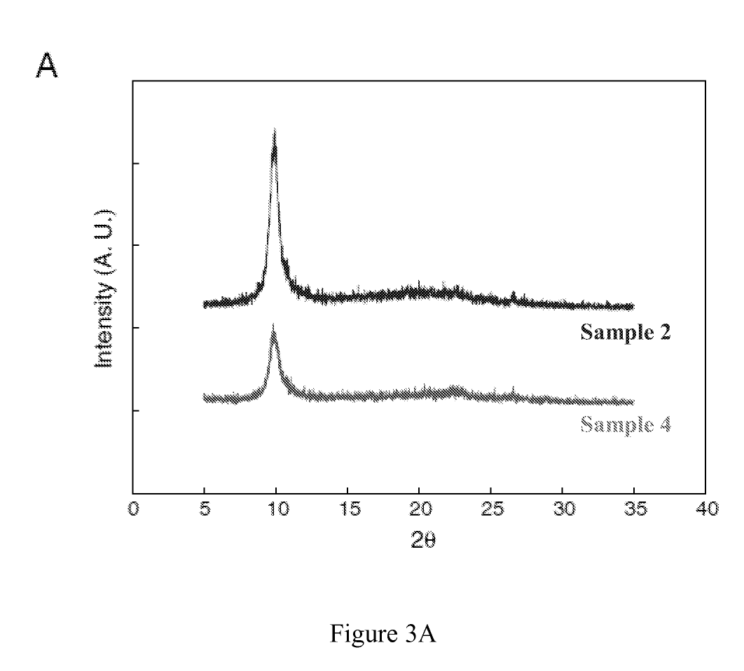

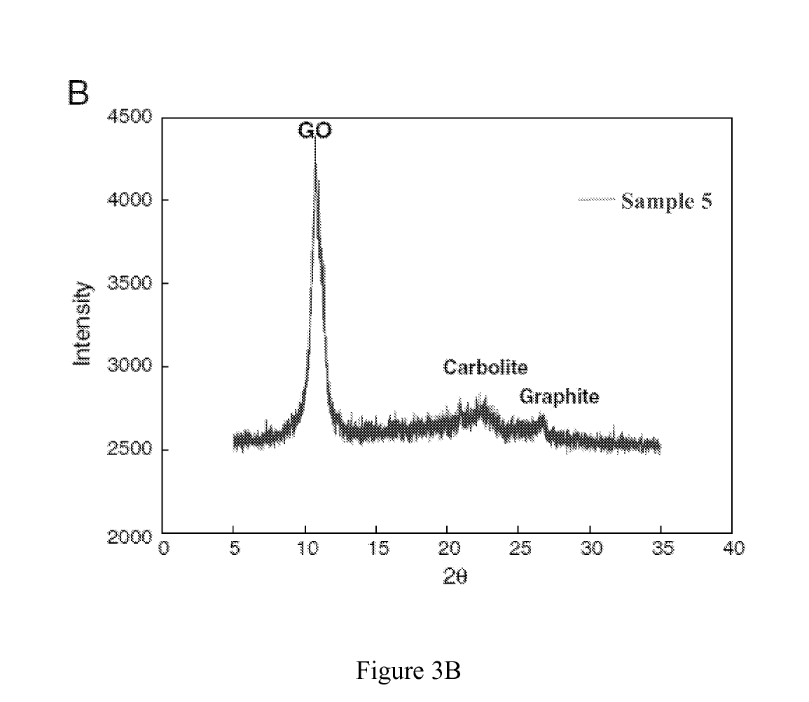

The XRD spectra of graphene oxide has diffraction peaks between 9.8° and 10.5°, as shown in the spectra of Samples 2 and 4 in FIG. 3A. Peak shifts are also observed in a few samples, such as Sample 5 in FIG. 3B. The diffraction peak of Sample 5 is at 10.7°, giving a positive peak shift of nearly 0.8° relative to that of Sample 2. In addition, the spectral line of Sample 5 also shows small humps at 22.3° and 26.7°, indicating the diffraction peaks of carbolite and graphite, respectively. This shows incomplete transformation of graphene oxide. Sample 5 has the lowest yield of all samples (see FIG. 2).

### (2) Raman Spectroscopy

The graphene oxide powder of Samples 1-9 obtained in Example 1 were subjected to Raman analysis. Data was collected by RM1000 Raman spectrometer (Renishaw) using a 633 nm laser.

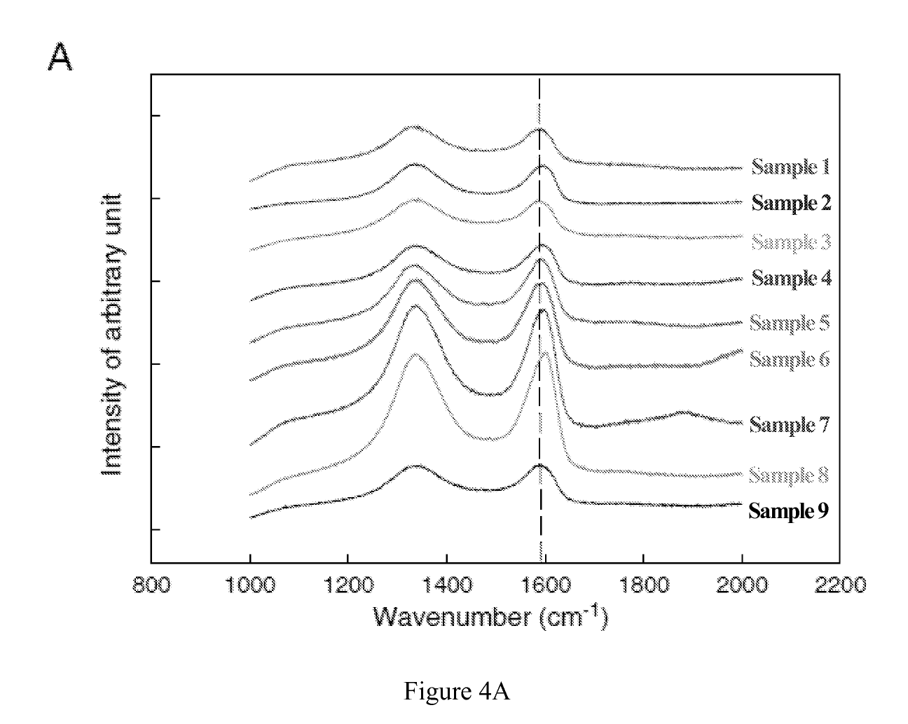

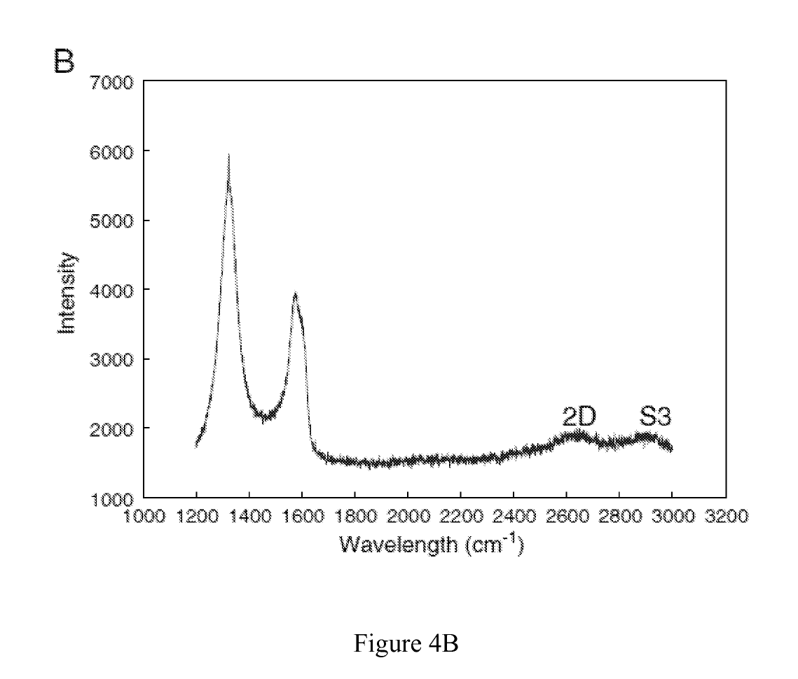

Raman spectra of all samples are shown in FIG. 4A. Two major peaks located near 1350 cm⁻¹ (the D-band) and 1580 cm⁻¹ (G-band) are observed in all spectra. The G-band signatures show that the graphene oxide comprises a graphite structure, and the D-band signatures indicate defects on the edges or surfaces of the graphene oxide. The G-band positions were determined and averaged at 1582.8 cm⁻¹ with a standard deviation of 0.5%. Also, the ratio of the D-band to G-band intensity, I_{D}/I_{G}, is averaged as 0.994 with a standard deviation of 1.7%. Furthermore, the average full-width at half-maximaum (FWHM) of the G-bands is 81.1 cm⁻¹ with a standard deviation of 5.1%. This indicates that the graphite clusters in the obtained graphene oxide examples vary slightly in their sizes.

FIG. 4B shows the Raman spectrum of Sample 2, showing the second order 2D graphene peak located at 2650 cm⁻¹ and S3 graphite peak located at 2914 cm⁻¹. The broadened 2D peak suggests the multi-layer nature of the graphene oxide of Sample 2.

The material used for preparing graphene oxide, Graphite flakes, is a block material. For producing graphene oxide, conventional wet-chemical method (ex. Hummers method) usually sieves and selects small graphite particles, cleaving the graphite layers thereof, and then synthesizing graphene oxide. The modified method of the present invention does not need the graphite particle sieving step at the beginning of the preparation. Instead, the graphene oxide having a few-layer structure can be obtained simply by sieving the synthesized graphene oxide by a #200 mesh filter. The graphene oxide having fewer layers results in a better conductivity. The Raman spectrometry shows that the graphene oxide of the present invention has a 2D graphene peak, which is a characteristic of the few-layer structure. In other words, it has proved the graphene oxide of the present invention has a few-layer structure.

### (3) Transmission Electron Microscopy (TEM) and Selected-Area Electron Diffractometry (SAED)

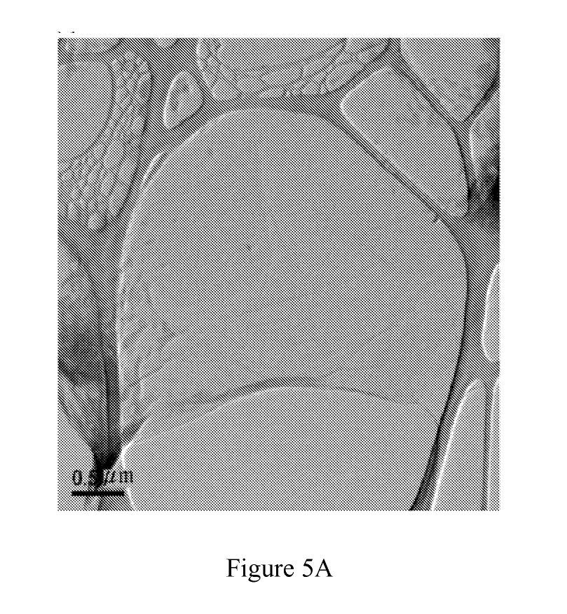

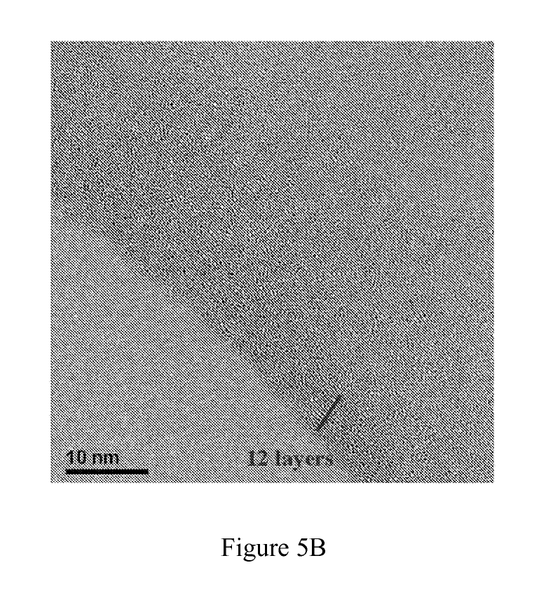

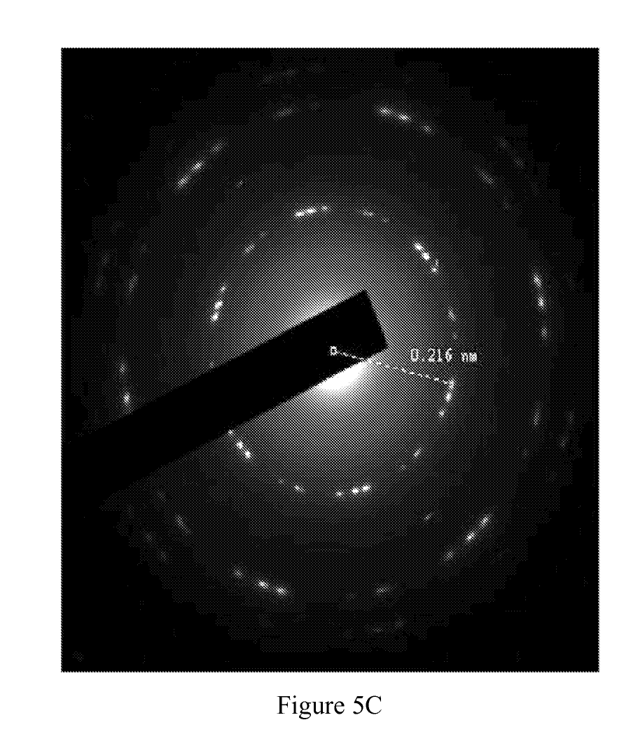

The graphene oxide powder of Samples 1-9 obtained in Example 1 were subjected to TEM and SAED analysis by STEM JEOL JEMF-2100 electron microscope. FIG. 5A shows the TEM image of Sample 2. It is obvious that the graphene oxide of the present invention is silk-veil-like. Although the graphene oxide has a few-layer structure, the graphene oxide sheets are highly transparent. The folded graphene oxide sheets can be observed at the bottom of the image. Another TEM image showing the curled edge of Sample 2 is represented in FIG. 5B. The line in this image indicates 12 layers of graphene oxide sheets. FIG. 5C shows the SAED pattern of Sample 2.

The above XRD analysis has proved that the graphene oxide of the present invention has a few-layer structure, and TEM and SAED demonstrate the morphology of the graphene oxide sheets of the present invention. As shown in FIG. 5(A), the graphene oxide is thin and silk-veil-like, which is the feature of the few-layer structure. No obvious crystal lattice is observed in the high solution TEM and SAED images (FIGS. 5(B) and 5(C)), but the number of layers can be estimated at the folding. In other words, the spacing between the layers was arranged regularly. In FIG. 5(C), sharp spots are observed. Since the sharp spots are the characteristic of crystal, it indicates that the graphene oxide sheets are not amorphous.

### (4) X-Ray Photoelectron Spectroscopy (XPS)

The XPS spectra were obtained using a 1486.6 eV Al anode X-ray source. Gold was generally comprised in XPS samples, so the charging effect had to be corrected by Au 4f PES peaks during the XPS measurements, and Shirley background was used for background correction. Xpspeak 4.1 software was used for peak fitting where the resulting peak components are pure Gaussian.

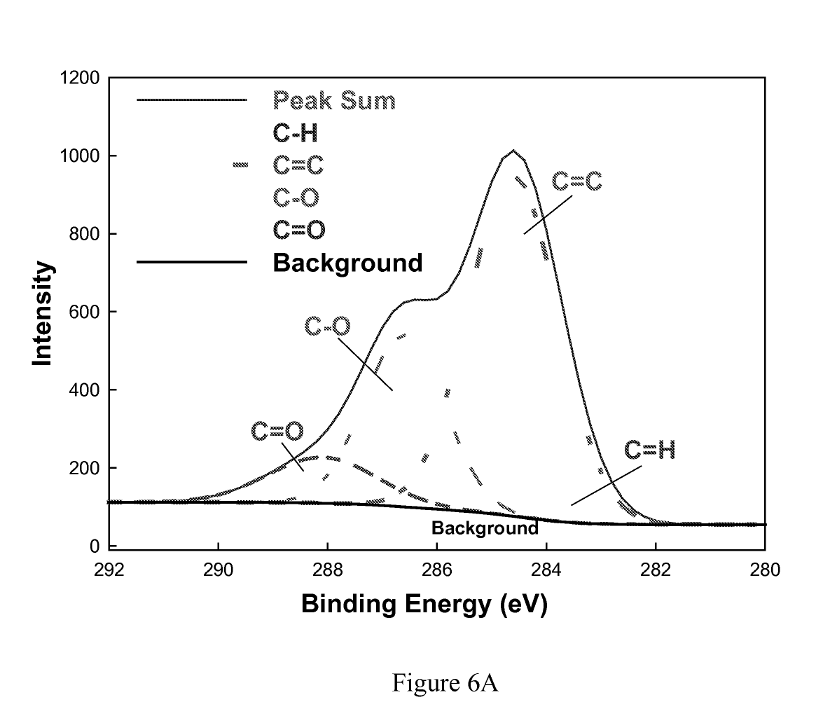

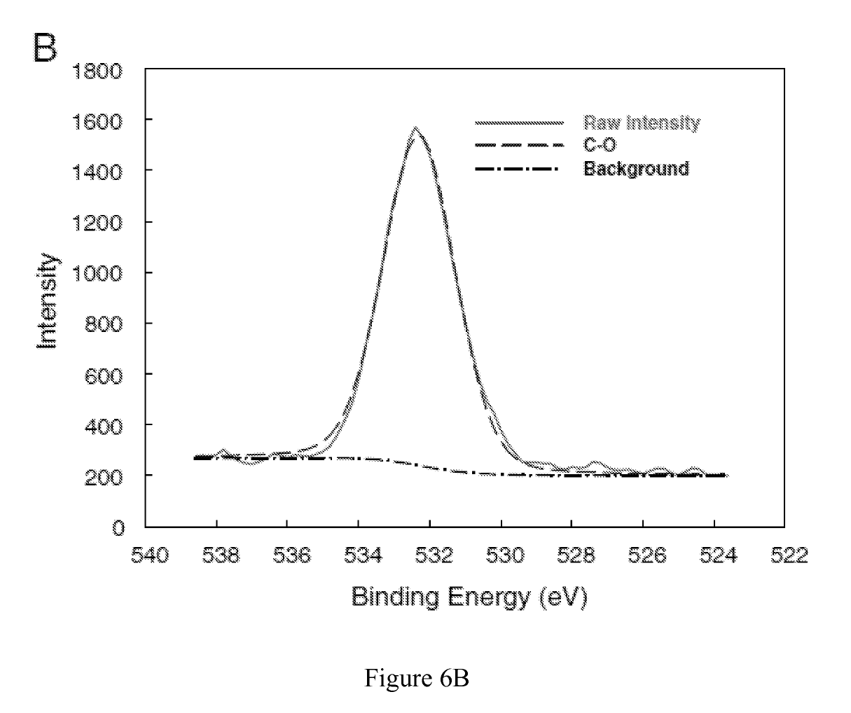

The surface chemistry of Sample 2 examined by XPS is shown in FIG. 6. The C1s and O1s of the graphene oxide of the present invention are located at 284.5 eV and 530 eV, respectively. FIG. 6A shows the detailed C1s spectrum of Sample 2. After deconvolution, three peaks were found: C═C, C—O and C═O peaks, which are located at 284.6 eV, 286.6 eV and 288.1 eV, respectively. The ratios of said C═C, C—O and C═O peaks were determined to be 64.18%, 27.38% and 8.44%, respectively. The ratio of “C═C” to “C—O”+“C═O” is 1:0.57, so the ratio of graphite structure and carbon-oxygen combination comprised in the graphene oxide of the present invention is 2:1. FIG. 6B shows the high-resolution O1s spectra of Sample 2, in which only C—O bonding is represented, and oxygen is absent.

### (5) Light Transmittance

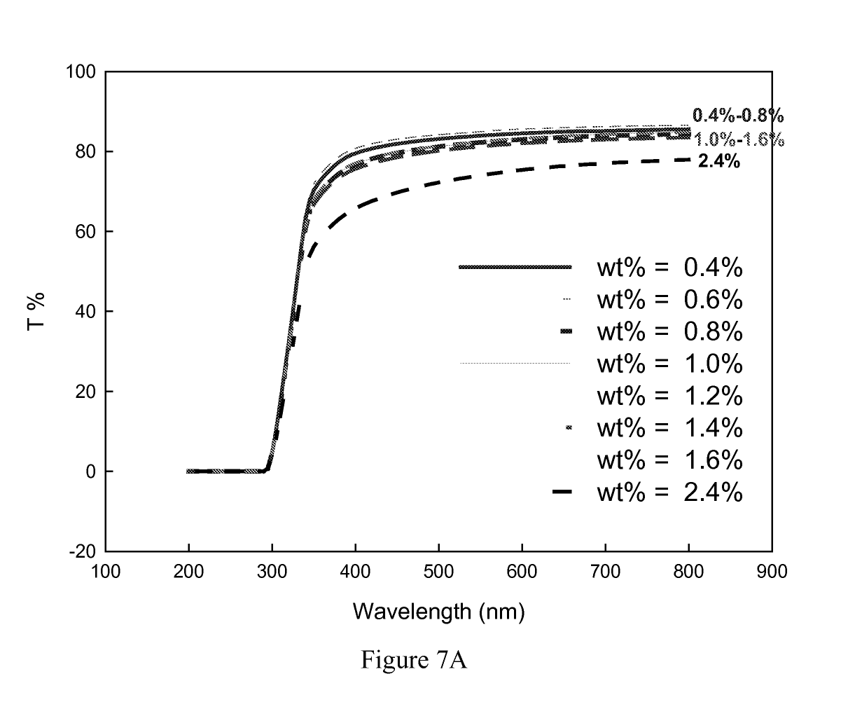

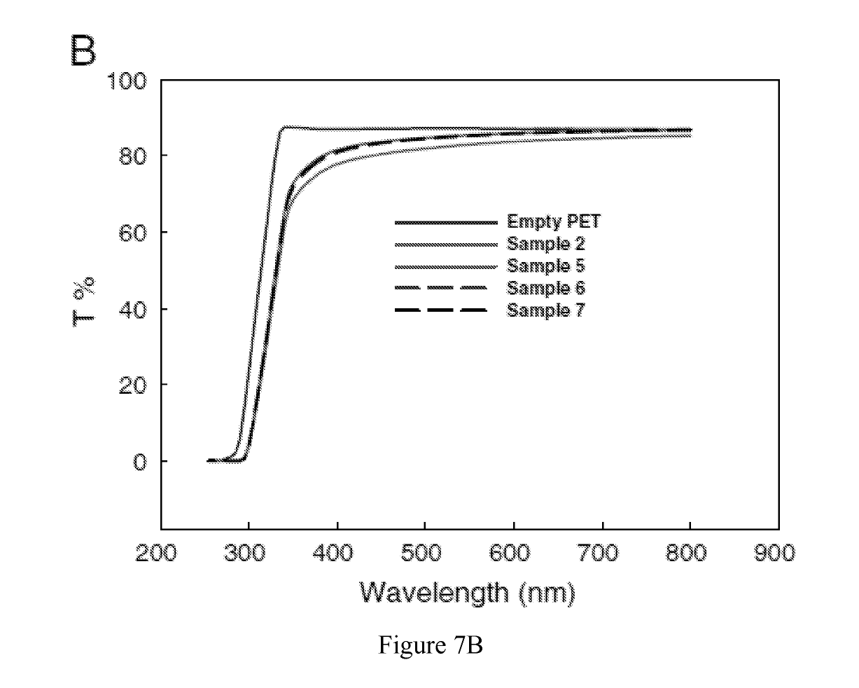

The graphene oxide Samples 1-9 were mixed with tetrahydrofuran (THF) to form various graphene oxide suspension having different graphene oxide concentrations. Each suspension was coated onto a polyethylene terephthalate (PET) substrate using spin-coating technique. The light transmittances of the obtained graphene oxide coatings were examined by Hewlett Packard 8453, and the results are shown in FIG. 7. The light transmittance of the graphene oxide of the present invention is 80% or higher.

FIG. 7A shows the light transmittance of coatings prepared by suspensions with different graphene oxide concentrations of Sample 2. In general, when the graphene oxide concentration increases, the transmittance reduces linearly. FIG. 7B shows the light transmittance of selected samples, in which the light transmittance of the coating of Samples 2, 6 and 7 are almost as good as the pure PET substrate. The light transmittance of Sample 5 is slightly reduced; this is because aggregations were found in the graphene oxide suspension.

The transparent graphene oxide coating prepared by wet-chemical method has a greater contact resistance in z-direction, which results in a reduced conductivity (data not shown). However, the light transmittance of such coating can reach 80% or more. So it can be used for manufacturing transparent layers comprised in applications, for example, touch keyboard, monitor, capacitor.

What is claimed is:

1. A method for preparing graphene oxide, comprising:
(a) adding sodium nitrate into sulfuric acid to obtain a sodium nitrate solution in sulfuric acid;
(b) adding graphite into said sodium nitrate solution in sulfuric acid to obtain expanded graphite;
(c) adding potassium permanganate into said expanded graphite, in which the ratio of sodium nitrate/potassium permanganate is 0.12-0.27, to obtain a graphite suspension;
(d) adding deionized water into said graphite suspension to control the yield of graphene oxide, in which said deionized water is added at a rate of 2-8 mL/min.

2. The method according to claim 1, wherein said graphene oxide is an amorphous graphene oxide having a layered structure.

3. The method according to claim 2, wherein said layered structure has 12 layers or less.

4. The method according to claim 1, further comprising: (e) filtering the graphite suspension obtained from step (d).

5. The method according to claim 4, further comprising: (f) purifying the filtrate obtained from step (e).

6. The method according to claim 1, wherein the ratio of sodium nitrate:sulfuric acid:graphite is 0.4-0.8 g:25-40 mL:1.3 g.

7. The method according to claim 1, wherein the ratio of sodium nitrate/potassium permanganate is 0.13-0.18.

8. The method according to claim 1, wherein said sodium nitrate is added at a rate of 6-10 mg/s.

9. The method according to claim 1, wherein said graphite is added at a rate of 2-6 mg/s.

10. The method according to claim 1, wherein said potassium permanganate is added at a rate of 12-18 mg/s.

11. The method according to claim 1, wherein said deionized water is added at a rate of 1-3 mL/min.

12. An amorphous graphene oxide having a layered structure, which is prepared by the method according to claim 1.

13. The amorphous graphene oxide having a layered structure according to claim 12, wherein said layered structure has 12 layers or less.
